(19) United States
(12) Patent Application Publication
(10) Pub. No.: US 2008/0126079 A1
(43) Pub. Date: May 29, 2008

(54) Handheld electronic device with automatic text generation

(75) Inventor: George Baldwin Bumiller, Ramsey, NJ (US)

Correspondence Address: Richard J. Coldren;Eckert Seamans Cherin & Mellott, LLC, 44th Floor, 600 Grant Street, Pittsburgh, PA, 15219, US

(73) Assignee: RESEARCH IN MOTION LIMITED

(21) Appl. No.: 11/336,797

(22) Filed: Jan. 20, 2006

(51) Int. Cl. G06F 17/20

(52) U.S. Cl. 704/9; 341/22

(57) ABSTRACT

A method of generating text on a handheld electronic device having an input apparatus, an output apparatus, and a memory having a number of language objects stored therein. The method comprises detecting a delimited input comprising a sequence of characters, determining at least a first property of at least the last character of the sequence of characters, and responsive to the determining, providing an output. An improved handheld electronic device implementing the method is also provided.

### BACKGROUND

1. Field

The disclosure relates generally to handheld electronic devices and, more particularly, to a handheld electronic device having an automatic text generation function and to an associated method.

2. Background Information

Numerous types of handheld electronic devices are known. Examples of such handheld electronic devices include, for instance, personal data assistants (PDAs), handheld computers, two-way pagers, cellular telephones, and the like. Many handheld electronic devices also feature wireless communication capability, although many such handheld electronic devices are stand-alone devices that are functional without communication with other devices.

Such handheld electronic devices are generally intended to be portable, and thus are of a relatively compact configuration. Many handheld electronic devices include a full keyboard (e.g., a full QWERTY keyboard). With advances in technology, however, a trend towards reduced keyboards is emerging, in which keys and other input structures often perform multiple functions or may otherwise have multiple aspects or features assigned thereto. As a practical matter, the keys of a keypad (whether reduced or not reduced) can only be minimized to a certain extent before the keys become relatively unusable. In order to enable text entry, however, a keypad must be capable of entering all twenty-six letters of the Latin alphabet, for instance, as well as appropriate punctuation and other symbols.

To improve text entry, a handheld electronic device may incorporate an auto-text function in which certain text that is entered using the keypad is automatically replaced with programmed text. More specifically, commonly misspelled words may be replaced with a correctly spelled word. When, for example, the characters “h”, “t”, and “e” followed by a delimiter (e.g., the actuation of the <space> key) are entered, the auto-text function replaces the text “hte” with the text “the” on a display. Additionally, common abbreviations may be replaced with the full word. When the characters “c”, “m”, and “d” followed by a delimiter (e.g., the actuation of the <space> key) are entered, for example, the auto-text function replaces the text “cmd” with the text “command” on the display.

Additionally, the auto-text function may be programmed to replace certain text that is entered using the keypad with programmed text that contains an apostrophe (or other punctuation, symbols, etc.). For example, when the characters “d”, “o”, “n”, and “t” followed by a delimiter (e.g., the actuation of the <space> key) are entered, the auto-text function replaces the text “dont” with the programmed text “don't”. As another example, when the characters “h”, “e”, and “l” followed by a delimiter (e.g., the actuation of the <space> key) are entered, the auto-text function replaces the text “hel” with the programmed text “he'll”.

Although generally helpful, the auto-text function may, in some instances, hinder a user from efficiently entering text. For example, a user may desire to enter the abbreviation for the word “identification”. However, when the characters “I” and “D” followed by a delimiter (e.g., the actuation of the <space> key) are entered; the auto-text function replaces the text “ID” with the programmed text “I'd”. Accordingly, most auto-text functions include an override capability. By activating the override capability, the word “I'd” may be changed back to the abbreviation “ID”. Activating the override capability, however, generally requires additional keystrokes or other input, thus negatively impacting a user's text entry efficiency.

It would be desirable to provide an improved handheld electronic device which is desirably configured with enough features to enable text entry and other tasks with relative ease. More specifically, it would be desirable for such an improved handheld electronic device to have improved auto-text functions.

### BRIEF DESCRIPTION OF THE DRAWINGS

A full understanding can be gained from the following Description of the Preferred Embodiment when read in conjunction with the accompanying drawings in which:

FIG. 1 is a top plan view of an improved handheld electronic device.

FIG. 2 is a schematic depiction of the handheld electronic device of FIG. 1.

FIG. 3 is an exemplary flowchart depicting certain aspects of an auto-text function that can be executed on the handheld electronic device of FIG. 1.

FIG. 4 is an exemplary flowchart depicting certain aspects of the auto-text function shown in FIG. 3 that can be executed on the handheld electronic device.

FIG. 5 is an exemplary flowchart depicting certain other aspects of the auto-text function shown in FIG. 3 that can be executed on the handheld electronic device.

Similar numerals refer to similar parts throughout the specification.

### DESCRIPTION OF THE PREFERRED EMBODIMENT

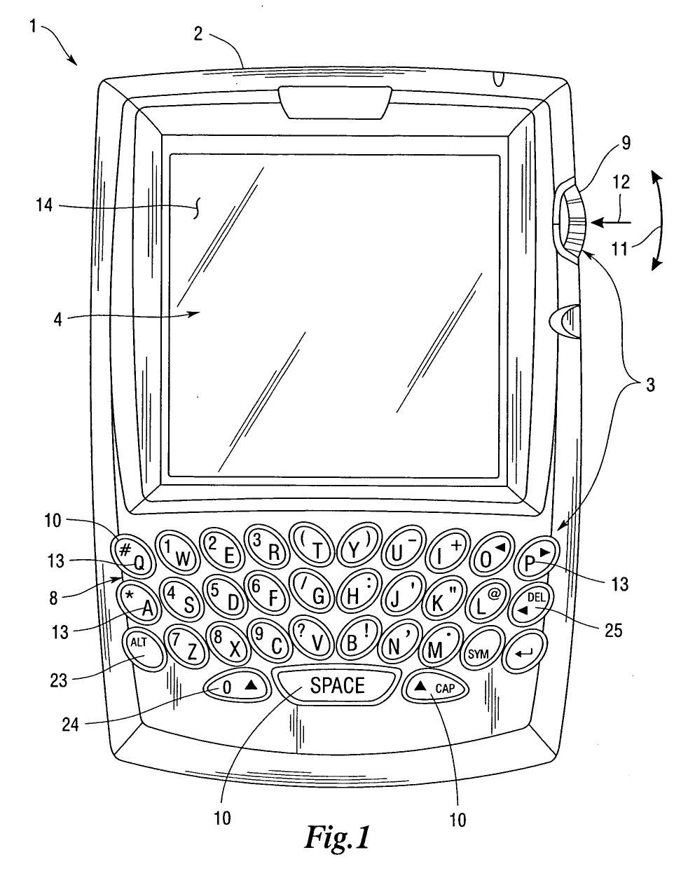

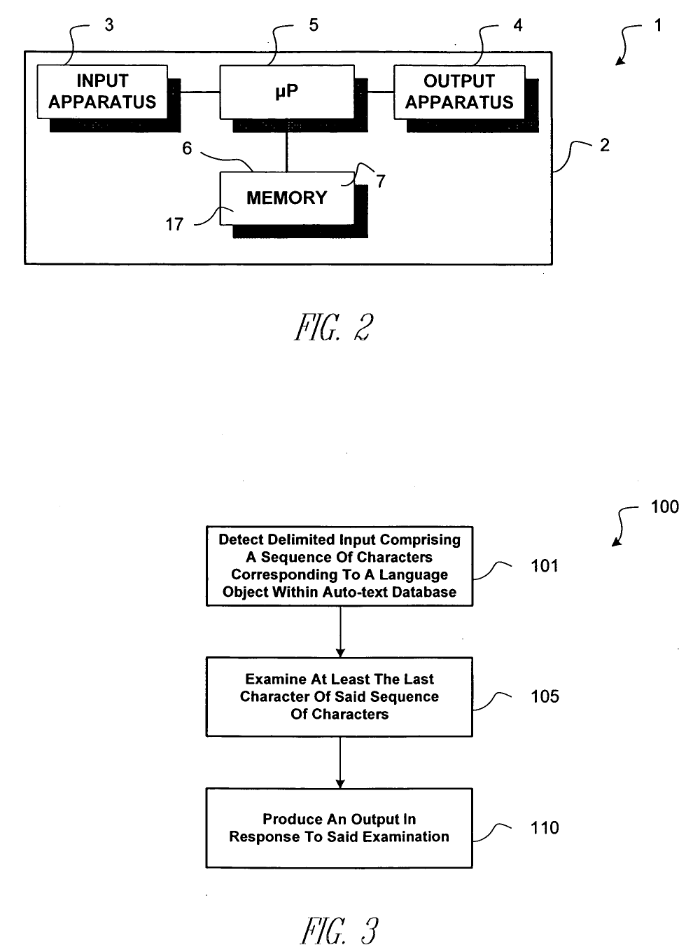

An improved handheld electronic device 1 is indicated generally in FIG. 1 and is depicted schematically in FIG. 2. The exemplary handheld electronic device 1 includes a housing 2 upon which are disposed a processor unit that includes an input apparatus 3, an output apparatus 4, a processor 5, and a memory 6 for storing at least a first routine 7 and an auto-text database 17. The processor 5 may be, for instance, and without limitation, a microprocessor (μP) and is responsive to inputs from the input apparatus 3 and provides output signals to the output apparatus 4. The output apparatus 4 includes a display 14 upon which can be provided an output (not shown in FIGs. 1 or 2). The processor 5 also interfaces with the memory 6 and is capable of executing the at least first routine 7 and accessing the auto-text database 17. Examples of handheld electronic devices are included in U.S. Pat. No. 6,452,588, U.S. Pat. No. 6,873,317, and U.S. Pat. No. 6,489,950, which are incorporated by reference herein.

As can be understood from FIG. 1, the input apparatus 3 includes a keypad 8 and a thumbwheel 9. As will be described in greater detail below, the keypad 8 is in the exemplary form of a full QWERTY keyboard including a plurality of keys 10 that serve as input members. It is noted, however, that the keypad 8 may be of other configurations, such as an AZERTY keyboard, a QWERTZ keyboard, or other keyboard arrangement, whether presently known or unknown.

As employed herein, the expression “linguistic element” and variations thereof shall refer broadly to any element that itself can be a language object or from which a language object can be constructed, identified, or otherwise obtained, and thus would include, for example and without limitation, characters, letters, strokes, ideograms, phonemes, morphemes, digits, and the like.

As employed herein, the expression “language object” and variations thereof shall refer broadly to any type of object that may be constructed, identified, or otherwise obtained from one or more linguistic elements, that can be used alone or in combination to generate text, and that would include, for example and without limitation, words, shortcuts, symbols, ideograms, and the like.

The keys 10 are disposed on a front face of the housing 2, and the thumbwheel 9 is disposed at a side of the housing 2. The thumbwheel 9 can serve as another input member and is both rotatable, as is indicated by the arrow 11, to provide inputs to the processor 5, and also can be pressed in a direction generally toward the housing 2, as is indicated by the arrow 12, to provide other input to the processor 5.

As can further be seen in FIG. 1, many of the keys 10 include a number of linguistic elements 13 disposed thereon. As employed herein, the expression “a number of” and variations thereof shall refer broadly to any non-zero quantity, including a quantity of one.

One of the keys 10 of the keypad 8 includes as the linguistic element 13 thereof the letter “Q”. An adjacent key 10 includes as the linguistic element 13 thereof the letter “W”. The next adjacent key 10 of the keypad 8 includes as the linguistic element 13 thereof the letter “E”, and the next adjacent key 10 includes as the linguistic element 13 thereof the letter “R”. It can be seen that the arrangement of the linguistic elements 13 on the keys 10 of the keypad 8 is generally of a QWERTY arrangement, albeit with many of the keys 10 also including other linguistic elements 13. As seen in FIG. 1, the key 10 having the letter “Q” also includes the linguistic element “#” thereon. The “#” symbol is generated on the display 14, for example, by actuating and holding “alt” key 23 in conjunction with actuating the “Q” key. Among the keys 10 of the keypad 8 additionally is a backspace key 25 that, as will be described in greater detail below, can be used to activate an auto-text override function.

The memory 6 can be any of a variety of types of internal and/or external storage media such as, without limitation, RAM, ROM, EPROM(s), EEPROM(s), and the like that provide a storage register for data storage such as in the fashion of an internal storage area of a computer, and can be volatile memory or nonvolatile memory. The memory 6 includes a number of routines depicted generally with the numeral 7 for the processing of data. The routines 7 can be in any of a variety of forms such as, without limitation, software, firmware, and the like. As will be explained in greater detail below, the routines 7 include an auto-text function as an application, as well as other routines.

The auto-text database 17 includes a number of language objects 21 stored therein. The contents of the auto-text database 17 may be established by, for example, the manufacturer and/or a user. Table 1 illustrates (without limitation) an exemplary listing of the language objects 21 and their corresponding sequence of characters stored within auto-text database 17. Each language object 21 corresponds to one or more sequence of characters. For example, the sequence of characters “c”, “a”, “n”, and “t” corresponds to the language object 21 “can't” in the auto-text database 17. Accordingly, if the keys <c>, <a>, <n>, and <t> are actuated in sequence followed by entry of a delimiter (e.g., actuation of the <space> key), the language object 21 “can't” is provided by the auto-text function to the processor 5 and output on display 14.

As illustrated in Table 1, the language object 21 “can't” corresponds to only one sequence of characters in the auto-text database. As a result, the language object “can't” will be output to the display 14 anytime the sequence of characters “c”, “a”, “n”, and “t” are entered followed by a delimiter, regardless of the case (i.e., upper or lower) of any of the characters in that sequence.

TABLE 1
Auto-text Database Contents

| Sequence of | Language |
|---|---|
| Characters | Object |
| arent | aren't |
| cant | can't |
| cmd | command |
| couldnt | couldn't |
| didnt | didn't |
| doesnt | doesn't |
| dont | don't |
| hadnt | hadn't |
| hasnt | hasn't |
| havent | haven't |
| hel | he'll |
| hes | he's |
| heres | here's |
| i | I |
| id | I'd |
| Id | I'd |
| iD | ID |
| ID | ID |
| il | I'll |
| im | I'm |
| Im | I'm |
| iM | IM |
| IM | IM |
| isnt | isn't |
| itll | it'll |
| itsa | it's a |
| ive | I've |
| sn | SN |

However, the correspondence between some language objects 21 and a sequence of characters may be case sensitive. For example in Table 1, the language objects 21 “I'd” and “ID” each correspond to the same sequence of characters, but the correspondence is case sensitive. More particularly, if the <i> and <d> keys on the handheld device are actuated in sequence followed by entry of a delimiter (e.g., actuation of the <space> key), the language object 21 “I'd” is displayed if both the “i” and the “d” characters are entered in lower case and/or the “i” character is entered in upper case and the “d” character is entered in lower case. In contrast, the language object “ID” is displayed if both the “i” and the “d” characters are entered in upper case and/or the “i” character is entered in lower case and the “d” character is entered in upper case. A similar result is obtained for the sequence of characters “i” and “m”. More specifically, depending on the case of the characters “i” and “m”, the language object 21 displayed may be “I'm” or “IM” (e.g., the abbreviation for “Instant Messaging”). In the current embodiment, the user is able to input an upper case character by, for example, actuating the <shift> key (either simultaneously with or prior to) the key associated with the desired character or by actuating and holding the key associated with the desired character for a predetermined period of time.

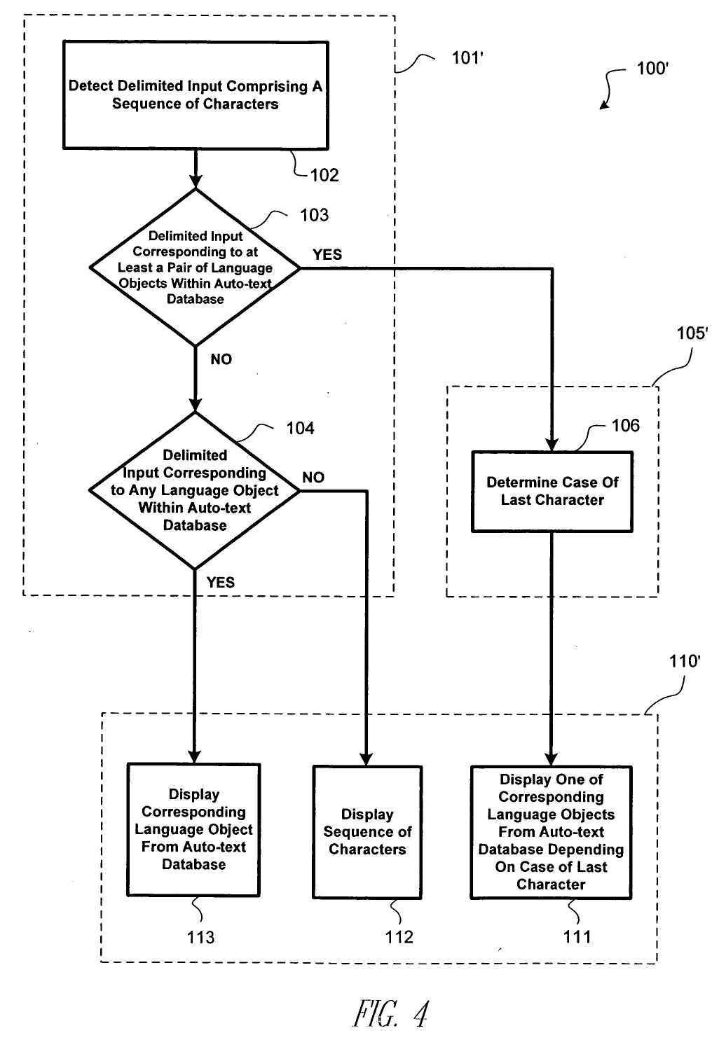

As discussed above, prior auto-text functions, in some instances, hinder a user from efficiently entering text. FIG. 3 is a flowchart illustrating operational process 100 for an improved auto-text function. Operational process 100 begins at operation 101 where a delimited input corresponding to a language object 21 within the auto-text database 17 is detected. For example, a user may enter the sequence of characters “c”, “a”, “n”, and “t” followed by a delimiter, such as actuation of the <space> key. Although the <space> key is used to enter the delimiter in the instant example, it should be apparent that other delimiters may be used.

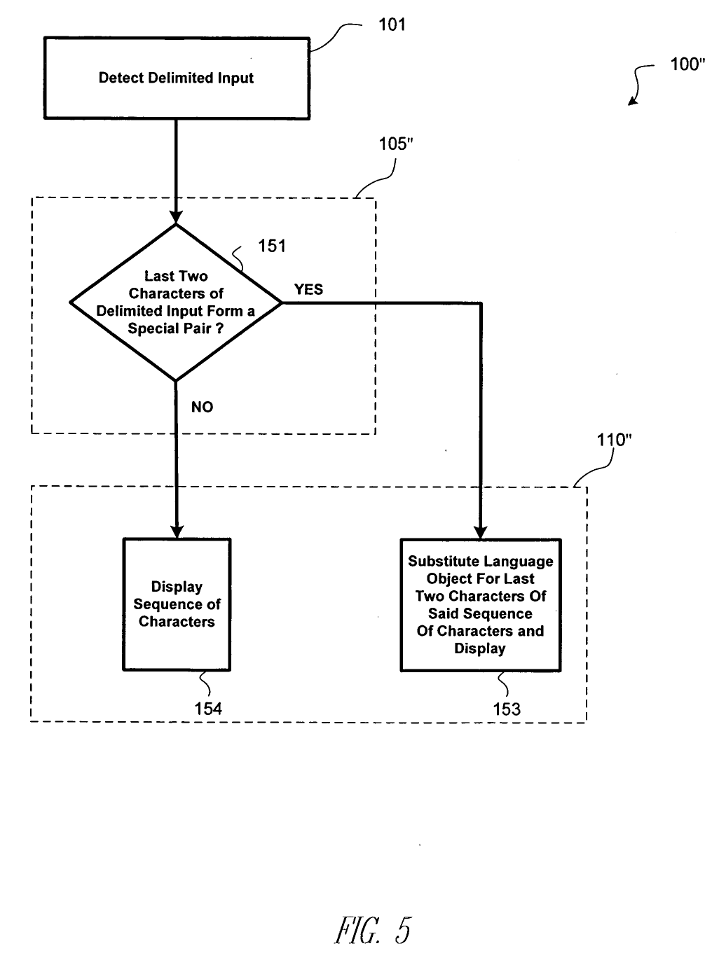

After the delimited input is detected in operation 101, at least the last character of the sequence of characters of the delimited input is examined in operation 105. For example in the embodiment that will be discussed in conjunction with FIG. 4, the last character of the sequence of characters of the delimited input is examined, whereas in the embodiment that will be discussed in conjunction with FIG. 5, the last character of the sequence of characters and the next-to-last character in the sequence of characters of the delimited input are examined. It should be apparent, however, that any desired number of characters in the sequence of characters may be examined. It should also be apparent that the particular location of the character(s) within the sequence of characters that is (are) being examined may vary. In response to operation 105, an output is produced in operation 110.

FIG. 4 is an exemplary flowchart depicting certain aspects of operational process 100 for the improved auto-text function as shown in FIG. 3. More specifically, FIG. 4 illustrates operational process 100′ which depicts certain aspects of the improved auto-text function. Operational process 100′ begins with operation 101′, which includes operation 102, operation 103, and operation 104. Operational control begins when operation 102 detects a delimited input comprising a sequence of characters. After the delimited input is detected at operation 102, a determination is made at operation 103 as to whether the sequence of characters of the delimited input corresponds to at least a pair of language objects 21 within the auto-text database 17. If the sequence of characters (regardless of their case) corresponds to at least a pair of language objects 21, control branches “YES” and passes to operation 105′ which includes operation 106. Operation 106 determines the case (e.g., upper-case or lower case) of at least one character of the sequence of characters of the delimited input; here, the case of the last character of the sequence of characters. Operational control then passes to operation 110′ which includes operations 111-113. In the current embodiment, operational control passes from operation 106 to operation 111 which outputs to the display 14 one of the at least pair of language objects 21 corresponding to the sequence of characters detected in operation 102. More specifically, in the current embodiment, operation 111 displays the language object 21 (of the at least pair of language objects 21) corresponding to the identified case of the last character of the sequence of characters of the delimited input (i.e., as determined in operation 106).

Returning to operation 103, if the sequence of characters is not associated with at least a pair of language objects 21 within an auto-text database 17, control branches “NO” and passes to operation 104. A determination is made at operation 104 as to whether the delimited input (regardless of the case of the sequence of characters) corresponds to any language object 21 within the auto-text database 17. If so, control branches “YES” and passes to operation 113 which outputs the corresponding language object 21 to the display 14. If the auto-text database 17 does not include any language objects 21 that correspond to the delimited input, operational control branches “NO” and passes from operation 104 to operation 112. In operation 112, the sequence of characters, as entered by the user, is output to the display 14.

In one example of the functioning of operational process 100′, a user attempting to input the abbreviation “ID” (i.e., short for the word “identification”) on the handheld device 1 inputs the characters “i” and “d”, and a delimiter (e.g., actuates the <space> key). More specifically, the user enters one of the following keystroke sequences: <i-d> <space>; <I-d> <space>; <i-D> <space>; or <I-D> <space >. This delimited input is detected at operation 102 and a determination is made at operation 103 as to whether this delimited input corresponds to at least a pair of language objects 21 within the auto-text database 17.

Here, the sequence of characters “i” and “d” does correspond to at least a pair of language objects 21 within the auto-text database 17 (e.g., “I'd” and “ID”). Accordingly, processing proceeds to operation 106 where the case (e.g., upper or lower case) of the last character of the sequence of characters is determined. For example, if the last character of the sequence of characters is in upper-case (i.e., if the user entered either <i-D> <space> or <I-D> <space >), the corresponding language object “ID” is provided as an output to display 14 in operation 111. If, however, the last character of the sequence of characters is in lower-case (i.e., if the user entered either <i-d> <space> or <I-d> <space>), the corresponding language object “I'd” is provided as an output to display 14 in operation 111.

In another example of the functioning of operational process 100′, a user inputs the characters “i” and “l”, and a delimiter (e.g., actuates the <space> key). More specifically, the user enters one of the following keystroke sequences: <i-l> <space>; <I-l> <space>; <i-L> <space>; or <I-L> <space>. This delimited input is detected at operation 102 and a determination is made at operation 103 as to whether this delimited input corresponds to at least a pair of language objects 21 within the auto-text database 17.

Here, the delimited input does not correspond to at least a pair of language objects 21 within the auto-text database 17. As a result operational control is passed to operation 104 where a determination is made as to whether the delimited input corresponds to a single language object 21 within the auto-text database 17. In the instant example, the delimited input does correspond to a single language object 21 within the auto-text database 17 (i.e., language object 21 “I'll”). Accordingly, that language object 21 (i.e., “I'll”) is provided as an output to display 14 in operation 113.

In yet another example of the functioning of operational process 100′, a user inputs the characters “i” and “t”, and a delimiter (e.g., actuates the <space> key). More specifically, the user enters one of the following keystroke sequences: <i-t> <space>; <I-t> <space>; <i-T> <space>; or <I-T> <space>. This delimited input is detected at operation 102 and a determination is made at operation 103 as to whether this delimited input corresponds to at least a pair of language objects 21 within the auto-text database 17.

Here, the delimited input does not correspond to at least a pair of language objects 21 within the auto-text database 17. As a result operational control is passed to operation 104 where a determination is made as to whether the delimited input corresponds to a single language object 21 within the auto-text database 17. In the instant example, the delimited input does not correspond to a single language object 21 within the auto-text database 17. Accordingly, operational control is passed to operation 112 and the sequence of characters, as typed by the user, is provided as the output on display 14. More specifically, when the user inputs the keystroke sequence <I-t> <space>, the text “It” is output to display 14.

Although not shown in FIG. 4, operational process 100′ may be subject to an auto-text override function. The auto-text override may be activated, for example and without limitation, by actuating the <back space> key. For instance, the language object “ID” corresponds to the keystroke sequence <i-D> <space> in the auto-text database 17 (as discussed above). Thus, the language object “ID” is output on display 14 in response to detection of the delimited key sequence <i-D> <space>. The key sequence <i-D> <space> <back space> <space>, however, activates the override function and cause the characters “iD” to be output on display 14.

FIG. 5 is an exemplary flowchart depicting certain other aspects of operational process 100 for the improved auto-text function as shown in FIG. 3. More specifically, FIG. 5 illustrates operational process 100″ which depicts certain aspects of the improved auto-text function. Operational process 100″ begins with the detection of a delimited input at operation 101. For example, a user may input a sequence of characters using a certain keystrokes. The keystrokes may include a delimiter, such as the actuation of the <space> key. As discussed above in conjunction with FIG. 3, although the <space> key is used as the delimiter in the instant example, it should by apparent that other delimiters may be used.

After the delimited input is detected at operation 101, operational control passes to operation 105″, which includes operation 151. A determination is made at operation 151 as to whether two characters within the sequence of characters form a special entry. More specifically, in the current embodiment, a determination is made at operation 151 as to whether the last two characters within the sequence of characters form a special entry. A “special entry” generally refers to two characters that typically do not occur adjacent to each other within a word in the particular language selected for use by the handheld electronic device 1, wherein one of the two characters also shares a key 10 assignment with a particular character such as, without limitation, <′>, <:>, </>, and <->. It should be noted, however, that a “special entry” may more broadly refer to any two characters that typically do not occur adjacent to each other within a word in the particular language selected for use by the handheld electronic device 1, regardless of whether one of the two characters also shares a key 10 assignment with a particular character and may also more broadly refer to any two characters designated to be special regardless of whether they typically occur adjacent to each other within a word in the particular language selected for use by the handheld electronic device 1.

For example, in one embodiment, the auto-text database 17 contains a number of sequences of characters and their corresponding language objects 21 for any number of special entries. Table 2 illustrates (without limitation) an exemplary listing of a number of sequences of characters and their corresponding language objects 21 for several special entries. Accordingly, in the current embodiment, the contents of auto-text database 17 are considered as one factor in determining in operation 151 whether the two characters form a special entry.

TABLE 2
Auto-text Database Special Entry

| Sequence of | Language | Sequence of | Language |
|---|---|---|---|
| Characters | Object | Characters | Object |
| js | 's | xh | x: |
| jd | 'd | jve | 've |
| jv | 'v | jll | 'll |
| jt | 't | sgn | s/n |
| jm | 'm | SGN | S/N |
| jl | 'l | cgn | c/n |
| nh | N: | sgnh | s/n: |
| dh | D: | SGNH | S/N: |

Returning to FIG. 5, if operation 151 determines that the last two characters of the sequence of characters form a special entry, operational control branches “YES” and passes to operation 110″ which includes operations 153 and 154. More specifically, operational control passes to operation 153. In operation 153, the language object 21 corresponding to the characters forming the special entry is substituted for the last two characters of the sequence of characters (i.e., for the special entry) and output to the display 14.

For example, a user attempting to type a word in the possessive form, such as “George's” would typically be required to actuate the <alt> key 23 in conjunction with actuating the <j/′> key to obtain the apostrophe ('). It is noted in this example (and as seen in FIG. 1) that key 10 having the character “j” assigned thereto, also has the character (') assigned thereto. In the current embodiment, the user simply enters the following keystroke sequence <G-e-o-r-g-e-j-s> <space> (i.e., the user does not need to actuate the <alt> key 23 to obtain the (')). The last two characters of this sequence of characters (i.e., “j” and “s”), which are typically not found adjacent to each other in a word within the English language (and which are contained within the auto-text database 17), are determined to be a special entry in operation 151. Accordingly, the language object 21 ('s) is substituted for the last two letters “js” in the sequence of characters. Thus, in the current example, when the user enters the keystroke sequence <G-e-o-r-g-e-j-s> <space>, the word “George's” is output on display 14.

As another example, a user attempting to type a word/abbreviation followed by a colon (:) would typically be required to actuate the <alt> key 23 in conjunction with an actuation of the <h/:> key to obtain the colon (:). However, with a handheld electronic device 1 that includes the improved auto-text feature illustrated in FIG. 5, a user attempting to enter, for example, “Fax:” would simply enter the keystroke sequence <F-a-x-h> <space> (i.e., the user does not need to actuate the <alt> key 23 to obtain the (:)). The last two characters (i.e., “x” and “h”) of this sequence of characters, which are typically not found adjacent to each other in a word within the English language (and which are contained within the auto-text database 17), are determined to be a special entry in operation 151. Accordingly, the language object 21 (x:) is substituted for the last two letters “xh” in the sequence of characters. Thus, in the current example, when the user enters the keystroke sequence <F-a-x-h> <space>, the output on display 14 is “Fax:”.

It should be noted that the (:), substituted at the end of the sequence of characters as discussed above, may also be considered as a delimiter. Accordingly, the sequence of characters (with the substituted character) may be reexamined. For example, when a user enters the keystroke sequence <i-D-h> <space>, the language object 21 (D:) is substituted for the last two letters “Dh” in the sequence of characters. The substituted (:) may then be considered as a delimiter and the language object “ID” may be substituted for the sequence of characters <i-D> as discussed above in conjunction with FIG. 4. Accordingly, when the keystroke sequence <i-D-h> <space> is entered, the output “ID:” may be displayed.

Returning to operation 151 in FIG. 5, if the last two characters of the sequence of characters do not form a special entry, operational control branches “NO” and passes to operation 154 where the sequence of characters, as entered by the user, are output to the display 14.

Although not shown in FIG. 5, operational process 100″ may be subject to an auto-text override function. The auto-text override may be activated, for example and without limitation, by actuating the <back space> key.

Although discussed in conjunction with two characters, it should be noted that any number of characters in a sequence of characters may be deemed a “special entry. For example, referring again to Table 2, the sequences of characters “jve”, “jll”, “sgn”, “SGN”, “cgn”, and “sgnh” (each consisting of three or more characters) may be deemed a “special entry”.

For example, a user attempting to type the contraction “should've” would typically be required to actuate the <alt> key 23 in conjunction with actuating the <j/′> key to obtain the apostrophe ('). In the instant example, the user simply enters the following keystroke sequence <s-h-o-u-l-d-j-v-e> <space> (i.e., the user does not need to actuate the <alt> key 23 to obtain the (')). The last three characters of this sequence of characters (i.e., “j”, “v”, and “e”), which are typically not found adjacent to each other in the English language (and which are contained within the auto-text database 17), are determined to be a special entry. Accordingly, the language object 21 “'ve” is substituted for the last three letters “jve” in the sequence of characters. Thus, in the current example, when the user enters the keystroke sequence <s-h-o-u-l-d-j-v-e> <space>, the word “should've” is output on display 14.

Although discussed in conjunction with a special entry in the auto-text database 17, it should be noted that other methods for determining whether two or more characters in a sequence of characters are a special entry and for substituting at least one character for one of the two or more characters may be utilized.

For example, an alternative method may comprise detecting a delimited input comprised of a sequence of characters, examining a first character and a second character, wherein the first and second characters are adjacent to one another in the sequence of characters, and providing an output that substitutes a character for at least one of the pair of characters of the sequence of characters when the first and second characters form a special entry. In this example, the first and second characters may be found to be special by determining that these two characters do not normally appear adjacent to each other within a word in the language selected for use by the handheld electronic device.

The substitute character may be determined, for example, by selecting a character that shares the same key 10 with the character to be replaced. For instance, if the user enters the keystroke sequence <G-e-o-r-g-e-j-s> <space> as discussed above, the first character of the pair of characters is “s” and the second character in the pair of characters “j”. As seen in FIG. 1, the character “j” shares the same key 10 as the character (') and the character “s” shares the same key 10 as the character “4” on the handheld electronic device 1. Accordingly, after it is determined that the characters “j” and “s” do not normally appear adjacent to each other within a word in English (e.g., the language selected for use by the handheld electronic device 1), a determination can be made as to whether the character (') or the character “4” is to be selected as a substitute character for the character “j” or the character “s”, respectively. Here the character (')is selected as a substitute character for the character “j” because, for instance, the substitution results in a word (e.g., “George's”) found in the English language, whereas the substitution of the character “4” for the character “s” results in a word (e.g., “Georgej4”) not found in the English language.

It should be noted that the other features of the auto-text function may be utilized in combination with the operational process 100″. For example, a user attempting to enter the abbreviation “SN:” would simply enter the keystroke sequence <s-n-h> <space> (i.e., the user does not need to actuate the <alt> key 23 to obtain the (:) and does not need to use upper-case letters when entering the keystroke sequence). More specifically, the last two characters of this sequence of characters (i.e., “n” and “h”) are typically not found at the end of a word in the English language and are determined to be a special entry. Thus, when a sequence of characters includes the characters “nh” as the last two characters, the language object 21 (n:) (corresponding to the sequence of characters “nh”) is substituted. Furthermore, other auto-text functions may determine that the characters “s” and “n” which were input in lower-case should be output as the letters “S” and “N” (i.e., output in upper-case). Accordingly, when the user enters the keystroke sequence <s-n-h> <space>, the abbreviation “SN:” is output on display 14. Alternatively, the sequence of characters “s”, “n” and “h” can simply be included in the Auto-text data base (i.e., Table 1) with the corresponding language object “SN:”.

While specific embodiments have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of generating text on a handheld electronic device having an input apparatus, an output apparatus, and a memory having a number of language objects stored therein, the method comprising:
detecting a delimited input comprising a sequence of characters;
determining at least a first property of at least the last character of said sequence of characters; and
responsive to said determining, providing an output.

2. The method of claim 1, further comprising:
detecting as the delimited input an input having a sequence of characters corresponding to at least a pair of language objects; and
responsive to said first property of said at least last character of said sequence of characters, providing as said output a language object of said at least a pair of language objects.

3. The method of claim 1 further comprising:
detecting as the delimited input an input having a sequence of characters corresponding to one of said language objects; and
providing as said output said one of said language objects.

4. The method of claim 1 further comprising:
detecting as the delimited input an input having a sequence of characters corresponding to none of said language objects; and
providing as said output said sequence of characters as input.

5. The method of claim 1 further comprising:
detecting as the delimited input an input having a sequence of characters, wherein at least two of said characters thereof comprise a special entry;
substituting a language object for said at least two of said characters of said sequence of characters; and
providing as said output said sequence of characters with said language object substituted for said at least two of said characters of said sequence of characters.

6. The method of claim 5 further comprising determining that said at least two of said characters thereof comprise a special entry.

7. The method of claim 6 wherein said determining comprises comparing said at least two of said characters of said sequence of characters to entries within an auto-text database.

8. The method of claim 1 wherein determining at least a first property of at least the last character of said sequence of characters includes determining the case of said at least the last character of said sequence of characters.

9. A handheld electronic device comprising:
a processor unit including a processor, an input apparatus, an output apparatus, and a memory having a routine stored therein and having a number of language objects stored therein, the routine being adapted to:
detect a delimited input comprising a sequence of characters;
determine at least a first property of at least the last character of said sequence of characters; and
responsive to said determining, provide an output.

10. The handheld electronic device of claim 9 wherein said routine is further adapted to:
detect as the delimited input an input having a sequence of characters corresponding to at least a pair of language objects; and
responsive to said first property of said at least last character of said sequence of characters, provide as said output a language object of said at least a pair of language objects.

11. The handheld electronic device of claim 9 wherein said routine is further adapted to:
detect as the delimited input an input having a sequence of characters corresponding to one of said language objects; and
provide as said output said one of said language objects.

12. The handheld electronic device of claim 9 wherein said routine is further adapted to:
detect as the delimited input an input having a sequence of characters corresponding to none of said language objects; and
provide as said output said sequence of characters as input.

13. The handheld electronic device of claim 9 wherein said routine is further adapted to:
detect as the delimited input an input having a sequence of characters, wherein at least two of said characters thereof comprise a special entry;
substitute a language object for said at least two of said characters of said sequence of characters; and
provide as said output said sequence of characters with said language object substituted for said at least two of said characters of said sequence of characters.

14. The handheld electronic device of claim 13 wherein said routine is further adapted to determine that said at least two of said characters thereof comprise a special entry.

15. The handheld electronic device of claim 13 wherein said routine is further adapted compare said at least two of said characters of said sequence of characters to entries within an auto-text database

16. The handheld electronic device of claim 9 wherein for determine at least a first property of at least the last character of said sequence of characters said routine is further adapted to determine the case of said at least the last character of said sequence of characters.

17. A method of generating text on a handheld electronic device having an input apparatus, an output apparatus, and a memory having a number of language objects stored therein, the method comprising:
detecting a delimited input comprising a sequence of characters associated with at least a pair of language objects within a database;
examining a last character of said sequence of characters;
providing as an output one of said at least a pair of language objects when said last character of said sequence of characters is input in a first case; and
providing as an output another of said at least a pair of language objects when said last character of said sequence of characters is input in a second case.

18. A method of generating text on a handheld electronic device having an input apparatus, an output apparatus, and a memory having a number of language objects stored therein, the method comprising:
detecting a delimited input comprising a sequence of characters;
examining a first character and a second character, wherein said second character is adjacent to said first character within said sequence of characters;
providing an output having a substitute character for at least one of said first character and said second character when said first character and said second character are special.

19. The method of claim 18 further comprising changing the case of at least one of said characters in said sequence of characters in response to said providing an output having a substitute character.
